(19) United States
(12) Patent Application Publication
(10) Pub. No.: US 2013/0029671 A1
(43) Pub. Date: Jan. 31, 2013

(54) COMMUNICATION SYSTEM

(71) Applicant: Sajid ISLAM, Fairfax, VA (US)

(72) Inventor: Sajid ISLAM, Fairfax, VA (US)

(21) Appl. No.: 13/192,837

(22) Filed: Jul. 28, 2011

(51) Int. Cl. H04W 40/02

(52) U.S. Cl. 455/445

(57) ABSTRACT

According to at least one exemplary embodiment, a system and method for communication may be described. A communication system can include a primary communication device; a software application installed on the primary communication device; a network; and at least one secondary communication device, wherein the software application detects incoming data transmissions to the primary communication device and routes the data over the network to the at least one secondary communication device. Thus, data can be replicated that is received on the primary communication device and may substantially simultaneously sent to the at least one secondary communication device, allowing a user to act upon the received data in real time, either from the primary communication device or any secondary communication device.

### BACKGROUND

The use of mobile phones and portable computing devices has become common. Individuals use mobile phones for any of a variety of manners of communication, such as voice communication, text message communication, multimedia message communication and other forms of electronic communication. Additionally, due to the prevalence of mobile phones and so-called smart phones, individuals are capable of browsing the internet or a network as well as sending email.

The nature of mobile phones, however, is that they typically do not work in all possible locations. For example, some phones have service providers who limit service geographically or nationally. Additionally, some service providers utilize GSM networks while others use CDMA. Even if the use of a mobile phone is possible in a remote location, for example a country different from the typical location of the individual with the mobile phone, use of the phone for voice or data communication may be prohibitively expensive. Still other issues arise in remote areas where there is very limited or no coverage. However, as is typical, many of these locations will maintain some form of wired communication, for example a telephone system, or a non-wired system, satellite connection that can allow for voice or data transfer, such as over the internet.

Mobile phones also are typically small so as to allow for easy carrying, transportation and use. However, as is the nature with small items, they are often forgotten, misplaced or lost. Thus, if the phone is misplaced or lost, or when travelling to a remote location, it is often the situation that an individual will not have phone service as desired. In each of these situations, it may still be desirable to connect to a mobile phone in a remote location over an established network that is not affected in order to receive or review any communications that were received by the phone

### SUMMARY

According to at least one exemplary embodiment, a system and method for communication may be described. A communication system can include a primary communication device; a software application installed on the primary communication device; a network; and at least one secondary communication device, wherein the software application detects incoming data transmissions to the primary communication device and routes the data over the network to the at least one secondary communication device.

In another exemplary embodiment, a method for remote communication may be described. The method can include steps for activating an application on a first communication device; configuring the application on the first communication device; detecting incoming data at the first communication device; intercepting the incoming data at the first communication device; and routing the incoming data to at least one secondary communication device.

### BRIEF DESCRIPTION OF THE FIGURES

Advantages of embodiments of the present invention will be apparent from the following detailed description of the exemplary embodiments. The following detailed description should be considered in conjunction with the accompanying figures in which:

FIG. 1 shows an exemplary diagram of a remote communications system.

FIG. 2 is an exemplary flowchart showing a remote calling system.

FIG. 3 is an exemplary flowchart showing a calling system.

FIG. 4 is an exemplary diagram showing a flow of a message from a primary device to a secondary device.

### DETAILED DESCRIPTION

Aspects of the invention are disclosed in the following description and related drawings directed to specific embodiments of the invention. Alternate embodiments may be devised without departing from the spirit or the scope of the invention. Additionally, well-known elements of exemplary embodiments of the invention will not be described in detail or will be omitted so as not to obscure the relevant details of the invention. Further, to facilitate an understanding of the description discussion of several terms used herein follows.

As used herein, the word “exemplary” means “serving as an example, instance or illustration.” The embodiments described herein are not limiting, but rather are exemplary only. It should be understood that the described embodiments are not necessarily to be construed as preferred or advantageous over other embodiments. Moreover, the terms “embodiments of the invention”, “embodiments” or “invention” do not require that all embodiments of the invention include the discussed feature, advantage or mode of operation.

Further, many of the embodiments described herein are described in terms of sequences of actions to be performed by, for example, elements of a computing device. It should be recognized by those skilled in the art that the various sequence of actions described herein can be performed by specific circuits (e.g., application specific integrated circuits (ASICs)) and/or by program instructions executed by at least one processor. Additionally, the sequence of actions described herein can be embodied entirely within any form of computer-readable storage medium such that execution of the sequence of actions enables the processor to perform the functionality described herein. Thus, the various aspects of the present invention may be embodied in a number of different forms, all of which have been contemplated to be within the scope of the claimed subject matter. In addition, for each of the embodiments described herein, the corresponding form of any such embodiments may be described herein as, for example, “a computer configured to” perform the described action.

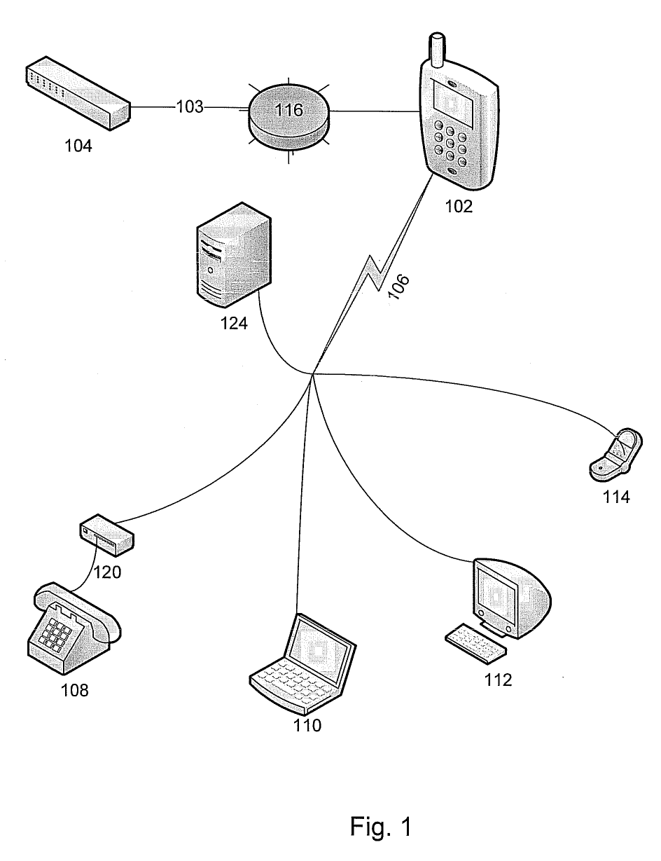

Generally referring to FIGS. 1-4, methods, systems and apparatuses for communication are disclosed. These can include the ability to view communications received on a communications device, remotely transmit data and remotely operate other features of a communication device. For example an interface may be used to replicate, remotely view, receive and access data on a mobile phone or device, and may then allow for the remote transmission or emulation of data from the mobile phone.

Referring now to exemplary FIG. 1, a method and system for replicating access and functionality of a primary communication device may be described. The primary communication device 102 may be any of a phone, mobile phone, smartphone or the like, for which there may be a desire to replicate, emulate or clone to allow for remote use. Additionally, the primary communication device 102 may be capable of making or receiving telephone calls, sending or receiving text messages, such as, but not limited to SMS, MMS and other types of messages, and sending and receiving any other form of data. Additionally, the primary communication device 102 may be capable of connecting to the internet in any known fashion, for example utilizing an interface or application connecting through a communications network 106 such as 3G or 4G, a local area connection (LAN), WiMax, WiFi, satellite internet connection and the like. In situations where a phone may not have internet accessibility, for example land line telephones, it may be made internet accessible through the use of an adapter, such as adapter 120. The adapter 120 may be a device which could be coupled inline between the phone and a wall jack, effectively providing a software layer and internet accessibility between the phone and the internet.

Still referring to exemplary FIG. 1, a method and system may be implemented that allow for varying levels of remote functionality of the primary communications device 102. Such functionality can include, but is not limited to, making or administering phone calls, messages, data and call logs in the absence of, or remotely from, the primary communications device 102. Such remote functionality of the primary communication device 102 may be desired in circumstances when the primary communication device is not accessible, when use or roaming charges may be high or in any other desired situation. The method and system can be used to replicate the access and functionality of any primary communication device 102 through any of a number of different manners. For example, a virtual switchboard, for example a server operating as a virtual switchboard, integrated through communications network 106 or a peer-to-peer network may be used. Additionally, any communications made using the methods and systems described herein may be encrypted and/or compressed in any known manner, as desired.

The virtual switchboard can include a fileserver application or software application that can connect any desired client devices to a primary device or emulate a primary device. The client devices, or any secondary devices, may be separate from the primary communication device 102 and may include a compatible application or software that may be installed and loaded on the primary communication device 102, as well as software that may be installed and loaded on the secondary devices, and may run in any of a variety of fashions, for example actively or passively, or may be deactivated. The remote communication system can provide for a layer that may detect, intercept, forward, replicate and/or emulate, as desired, and distribute incoming data to the primary communication device and route it to one or more secondary devices. Additionally, the intercept layer 116 can be activated and utilized on primary device 102 and may be capable of communicating with and sharing data with a remote server 124 on network 106. The intercept layer 116 may, at a user's discretion, have the ability to direct calls or data to any desired devices, as described herein. Such incoming data, as previously described, can be a phone call or data message, amongst others. For example, when a call or message is received at the primary communication device 102, for example from an outside device 104 that transmits over a network 103, the intercept layer 116 can detect the incoming call or message and replicate or forward the call or message to any desired secondary device substantially simultaneously. A call may be emulated, replicated or forwarded in any desired manner, for example over the internet as a voice over internet protocol (VOIP) call. Similarly, a message, such as a text message, may be replicated or distributed as data over the internet. A secondary device may be a traditional phone 108 coupled with an adapter 120, a mobile phone 114, a computer 110 or 112 or any other form of communication device. Further, in some exemplary embodiments, the server 124 may function as the secondary device insofar as it may be accessed through a web portal or interface and allow the sending and receiving of voice call and data messages, for example, directly from the server 124. For example, if a call is being directed to the primary communication device 102, it may be detected at the intercept layer 116 and replicated or distributed. A secondary communication device, or any number of secondary communication devices, such as telephone 108, portable computer 110, computer terminal 112 or mobile phone 114, connected to the intercept layer 116 via any form of data or communication network, such as network 106 may then be alerted of the incoming call at the primary communication device 102. The alert may be any known alert, for example a ringtone, vibration, visual cue or the like, as desired. Additionally, any secondary communication device 108, 110, 112 or 114 can be configured to receive and provide an alert or cue that an incoming call or data is occurring. Further, if multiple secondary communication devices 108, 110, 112 or 114 are configured, they may be alerted or cued simultaneously or substantially simultaneously to both the primary communication device 102 and each other. Such communication and data transmission may be performed in any manner known in the art.

Still referring to exemplary FIG. 1, when an alert or cue is shown on any or all secondary communication devices 108, 110, 112 or 114, a user may, at their discretion, choose to answer a call, view a message or take whatever action is desired to receive or view the incoming information. The data may then be routed from the intercept layer 116 to the secondary communication device 108, 110, 112 or 114 through a communication or data network 106, such as the internet or through the server 124, as desired. For example, when a call is received that is intended for the primary communication device 102, the call may detected and intercepted by the intercept layer 116, converted into VOIP format, routed over the internet (as network 106) and received at a secondary communication device 108, 110, 112, 114, or 124. The call may then be answered or not answered at a user's discretion. If the call is answered, for example at secondary device 108, software associated with interception layer 116 can connect the call through the internet and emulate the primary communication device 102 on the secondary device 108. Further, the call, or a conversation, in some exemplary embodiments, may be recorded in a call log that can be independently accessible through any of the primary communication device 102 or secondary devices 108, 110, 112 or 114, as well as an online interface 124.

In a farther exemplary embodiment, if a data message, such as an SMS or text message, is sent to the primary communication device 102, the interception layer 116 can intercept the message and replicate it. The replicated message may then be sent to any desired secondary devices, such as devices 108, 110, 112, 114 and 124 simultaneously or substantially simultaneously. Upon access of the message on at least one of the secondary devices 108, 110, 112 and 114, an indication that the message has been read on one of the devices may be sent to intercept layer 116 and intercept layer 116 may then send a communication to any other secondary devices where the message was not previously accessed that the message has been read. Further, the message may be stored at the primary communication device 102 or secondary devices 108, 110, 112 or 114, as well as an online interface 124.

In still another exemplary embodiment, a user can make a phone call through any secondary devices, such as devices 108, 110, 112 and 114. For example a user may desire to make a call from computer terminal 112 and want it to appear as though the call is originating from primary device 102 or otherwise utilize benefits of having the call routed through primary device 102, for example the avoidance of long distance charges, roaming charges or international calling fees. In such a situation, an emulation phone number, such as the phone number for primary device 102, may be selected at computer terminal 112. Alternatively, the emulation number may be any desired number or the lack of a number. Then, using known methods, a call may be placed on a secondary device and routed over a network, such as the internet using VOIP. The call may then go through primary device 102, pass through intercept layer 116 and directed to the desired party or device. Intercept layer 116 may, in some exemplary embodiments, be utilized to route the call as either a standard call or as a VOIP call over a network. The party or device receiving the call may be provided with information, such as caller ID information, that makes it appear the call is originating from primary communication device 102. In still another exemplary embodiment, peer-to-peer calls may be made from a secondary device through the primary device 102 to any other desired communication device, for example any desired telephone or device accessible through a telephone call. In still another exemplary embodiment, a peer-to-peer call may be from any secondary device to the primary device 102. In such exemplary embodiments, the secondary device may call, over network 106, any desired number at a desired location, using software or an application associated with the secondary device. The intercept layer 116 may then receive or intercept the call and then pass it on to the desired destination. Such a call may be made over a network or through use of the calling (or, in other exemplary embodiments, data sending) capabilities of primary device 102. Additionally, any calling information may be emulated by intercept layer 116 so that, when the call is received at the desired location, it appears that the call originated at primary device 102. It may be appreciated that the system described herein may utilize a peer to peer data transmission and calling scheme or utilize a scheme whereby all data is transmitted through central server 124. Additionally, the system may be set to utilize one or the other methodology or the system may switch dynamically between the two, depending on any desired circumstances.

In a similar exemplary embodiment as above, a user can send a text or data message through any secondary devices, such as devices 108, 110, 112 and 114. For example a user may desire to send a text message from computer terminal 112 and want it to appear as though the message is originating from primary device 102 or otherwise utilize benefits of having the message routed through primary device 102, for example the avoidance of long distance charges, roaming charges, data usage fees or international calling fees. In such a situation, an emulation phone number, such as the phone number for primary device 102, may be selected at computer terminal 112. Alternatively, the emulation number may be any desired number or the lack of a number. Then, using known methods, a message may be sent from a secondary device and routed over a network. The message may then go through primary device 102, pass through intercept layer 116 and directed to the desired party or device. Intercept layer 116 may, in some exemplary embodiments, be utilized to route the message as through a data network or over the Internet. The party or device receiving the message may be provided with information, such as caller ID information, that makes it appear the message is originating from primary communication device 102. In still another exemplary embodiment, a peer to peer message may be sent from a secondary device through the primary device 102 to any other desired device, for example a telephone or device accessible with a telephone number, or may be sent directly to primary device 102. In such exemplary embodiments, the secondary device may send a message, over network 106, to any desired number at a desired location, using software or an application associated with the secondary device. The intercept layer 116 may then receive or intercept the message and then pass it on to the desired destination. Such a message may be made over a network or through use of the messaging (or, in other exemplary embodiments, data sending) capabilities of primary device 102. Additionally, any message information may be emulated by intercept layer 116 so that, when the message is received at the desired location, it appears that the message originated at primary device 102. It may be appreciated that the system described herein may utilize a peer to peer data transmission and messaging scheme or utilize a scheme whereby all data is transmitted through central server 124. Additionally, as above, the system may be set to utilize one or the other methodology or the system may switch dynamically between the two, depending on any desired circumstances. Similar to previously described exemplary embodiments where a message that is read on a secondary device can be marked as “read” on any other devices where the message was not read, when a message is sent from a secondary device, through a primary device, the other secondary devices can have the same message saved thereon, for example in a sent box.

In another exemplary embodiment, intercept layer 116 and any software applications or components associated therewith, may incorporate a data storage or voice messaging system. In such an embodiment, if an incoming voice call is directed towards primary communications device 102, intercepted at intercept layer 116 and routed to one or more secondary devices 108, 110, 112 and 114, and is not received or answered at any of those devices, a voice messaging system at the intercept layer 116 may be activated. The voice messaging system at intercept layer 116 can be such that any desired greeting is played and then a caller is allowed to record his or her message, as is known. The voice messaging system may allow for activation after any desired number of rings and may further be provided with transcription service that can email or text message the contents of a voice message to any desired location or communication device. Further, in some exemplary embodiments, voicemail at intercept layer 116 may be activated or deactivated depending on any of a variety of conditions. For example, voicemail at the intercept layer 116 may be enabled if there is no voicemail functionality at primary communication device 102, if the voicemail at primary communication device 102 is turned off or if the voicemail at intercept layer 116 is activated following fewer rings that that which is set for the voicemail at primary communication device 102. Further, depending on a user's preferences, any voicemail received on the primary communication device 102 may be reviewed directly through any secondary communication device or voicemail may be reviewed, for example, online through an application or interface. Any such voicemail may then be accessed through the primary communication device 102 or secondary devices 108, 110, 112 or 114, as well as an online interface 124.

In a further exemplary embodiment of FIG. 1, adapter 120 may be utilized with a standard telephone, such as telephone 108, in order to provide the telephone 108 with internet or network connectivity and the capability of receiving incoming data, transmitting outgoing data and displaying data from the internet or network 106. Adapter 120 may be such that it connects to a network 106 in either a wired or wireless fashion. Further, adapter 120 can be such that normal functionality of telephone 108 is not affected and it may be activated, deactivated or work passively until needed. Additionally, in some exemplary embodiments, the primary device 102 may be a standard telephone, such as a landline telephone without any connectivity to the internet or network 106. In such embodiments, adapter 120 may be utilized with primary device 102 so as to allow the standard telephone to have any of the functionality of a primary device 102 described herein.

In some exemplary embodiments, adapter 120 may be such that it connects to both a standard telephone 108 as well as a computer (not pictured). In such embodiments, the computer or another direct connection may be utilized to connect the adapter 120 and telephone 108 to the internet. In still other embodiments, the adapter 120 may be a stand-alone device that connects directly to the phone and the internet in any wired or wireless fashion. Any setup or configuration of the adapter 120 and telephone 108 may be done through an interface, such as a display and controls, associated with adapter 120, an interface found on a computer connected to adapter 120 or through an interface on the internet.

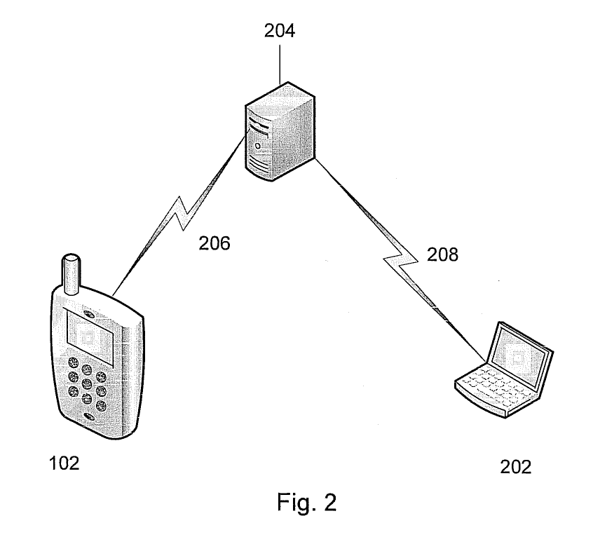

In another exemplary embodiment, and referring now to FIG. 2, intercept layer 116 may be activated and utilized in any of a variety of manners. For example, a user may have primary communication device 102 which is used for day-to-day use in a primary location or region. However, primary communication device 102 may not have connectivity or full functionality outside of a primary location or region, may be undesirable to carry or may be forgotten, for example, thus making emulation of device 102 from a remote location desirable. Thus, to activate a remote communication system, a user may download and activate an application or software on primary communication device 102. The application can be such that it runs actively, runs passively in the background of an operating system of primary communication device 102 or may be turned off or otherwise deactivated. Additionally, the application may be such that it functions when the primary communication device 102 is activated or turned on.

Still referring to exemplary FIG. 2, after the application is loaded onto primary communication device 102, an interface, such as an interface associated with the application or an internet-accessible interface, may be provided that allows a user to set up their desired settings for remote communications, such as the replicating, emulating or forwarding of calls or data, or the emulation of the primary communication device 102 through a secondary communication device 202. Here a user can activate the remote communication system, set up voicemail or message replicating, emulating or forwarding, and the like. The remote communication system may then be activated and utilized. In some further exemplary embodiments, it may be desired to have primary communication device 102 coupled to a power supply during any remote use, for example, to prevent the potential loss of power or service to the primary communication device 102.

In exemplary FIG. 2, secondary communication device 202 may be any device, as described previously, capable of accessing a data or communications network, such as network 208, which may be the interne or peer-to-peer communication. In order to activate the remote communication system such that secondary communication device 202 may be capable of receiving incoming calls or messages originally destined for primary communication device 102, the secondary communication device 202 can utilize, for example, software or an application to remotely access data, transfer data or remotely communicate with other devices utilizing the system. In some examples, this could include logging into a website, downloading and/or opening an application, and the like. The server 204 may then establish that the secondary communication device 202 is associated with primary communication device 102 and, depending on the desired settings of the remote communication system application on primary communication device 102, replicate, emulate or forward appropriate calls and messages incoming to primary communication device 102 as well as emulate calls from secondary communication device 202 so that they appear to be from primary communication device 102. Additionally, it may be possible to have a number of different secondary communication devices simultaneously communicatively coupled to server 204 or in a peer-to-peer fashion and capable of receiving any call or message data replicated, emulated or forwarded from primary communication device 102.

In still further exemplary embodiments, the application housed on primary communication device 102 may allow for the access of any data, for example stored contact information, call history, previously-received text messages, as well as any other data stored on the primary communication device 102, by the secondary communication device 202. Such data may be made available through the transmission of data from primary communication device 102, through the application and to server 204, or directly from primary communication device 102 to secondary device 202 in a peer to peer fashion. Further, it should be understood that in any exemplary embodiment described herein, data may be routed over a server, such as server 204 or from a primary device to a secondary device in a peer to peer manner, for example directly from primary device 102 to secondary device 202. Requests, searches and inquiries, as well as data browsing, may then be conducted using the secondary communication device 202. Secondary devices can all be updated substantially simultaneously with such information or such information may all be available from a centralized location that provides any calling or messaging history, contact information or access to any other information, for example, found on primary device 102. Thus, for example, the secondary device 202 can have a virtual screen of device 102 which may allow for the modification of settings, performance of other functions (such as, but not limited to updating contacts) of device 102 from device 202, as if a user were directly interacting with device 102. Because of this virtual capability, settings such as screen brightness, ringtone, and further phone-specific settings of device 102 can be accessed and updated from the virtual screen on device 202.

After the remote communication system is activated using an appropriate application or software on primary communication device 102, any desired calls or messages may be accessed remotely and in real time at a secondary communication device 202, for example, as the call or message is transmitted to the primary communication device 102. Thus, when the remote communication system is activated, an incoming call or message can be received at primary communication device 102. The application, functioning as an intercept layer (similar to that described above), can intercept, replicate, emulate, distribute or forward the call or message over network 206 to server 204 (or in a peer to peer fashion, as described above). Server 204, which may be a single server or any number of servers, may route the call or message to the secondary communication device 202.

In some further exemplary embodiments, a remote calling system can be set up and interacted within any of a variety of manners. For example, in situations where a primary communication device, such as device 102 of FIG. 2, does not have a remote calling system, it may be downloaded from the internet or an appropriate application store and installed. A user may then create an account with the remote calling system, for example through an interface. After creating an account and logging in, the user can then designate certain terms of use, such as a nickname for any primary or secondary communication devices, select options for synchronizing and reviewing call logs, voicemail, sent and received messages or any other log data that may be associated with mobile phones. Further, any desired data may be imported into the remote calling system and made available to any secondary device individually or collectively, or made available on the central server that can be accessed, for example, though a web portal or online interface, such as address or phone book information, pictures, old messages or any other data presently stored on the primary device 102. Other desired settings may also be made through the web interface, such as designating secondary devices, designating desired ring settings for any secondary devices (such as making a number of secondary devices ring simultaneously), replicating, emulating, distributing or forwarding of calls or data to another phone number, and setting up a voicemail system, synchronizing the remote calling system with other communication methodologies, such as email, or adjusting any other feature, aspect or application.

In other exemplary embodiments, for example where a user is logging in to a remote communication system using a computer (or other non-telephone device), the user may designate an appropriate device phone number to be utilized, for example from a list of available phone numbers. Additionally, a user may select microphone and speaker options or, if such items are not available, designate such a device for only receiving and sending message data or for receiving voicemail transcripts. Further, the user may then, when accompanied by the appropriate hardware, make and receive voice calls from a computer or other non-telephone device that can, for example, make it look like the call or data originated from the primary device 102 that was selected from the list of available devices, and traveled in a manner that was described earlier.

In yet another exemplary embodiment, and referring back to FIG. 2, calls from a primary device 102 or secondary device 202 may be made with or without the remote communication system. For example, if the remote communication system application is actively running on secondary device 202, any call made from that device could be converted into, for example, a VOIP call and routed through server 204 (or in a peer to peer fashion) to the desired recipient, e.g. the device of the number called. Additionally, if the secondary device 202 has the remote communication system application running in the background or passively, it may be possible to dial a desired sequence of numbers or symbols, in order to make the secondary device 202 call using the remote communication system. For example, if a user desires to call using the system, they may preface a dialed number with the prefix of “*9”, or any other desired prefix, as could be configured in an interface associated with the remote calling system, and the call made from that device could be converted into, for example, a VOIP call and routed through server 204 (or in a peer to peer fashion) to the desired recipient. Similarly, if the user is utilizing a primary device 102 with telephone or calling capabilities, the same or similar methodologies could be used or employed to make calls with or without the remote calling system. Further, this methodology can similarly be utilized when sending a message, such as a text message from either a primary device 102 or secondary device 202, as desired. Sajid

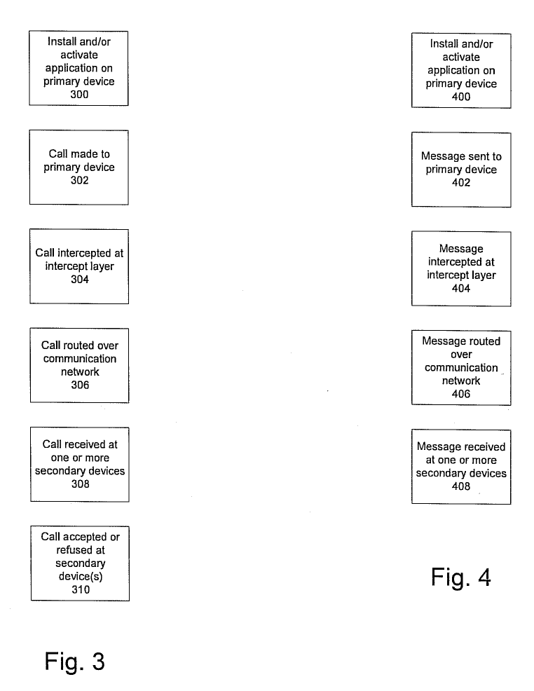

Referring now to exemplary FIG. 3, a flowchart showing a process for replicating, emulating, distributing or forwarding a call may be shown. In step 300, an application for a remote communication system may be installed or, if it is already installed, activated on a primary communication device. This can include software that is capable of communicating with a remote server or in a peer to peer manner to share data on the primary communication device as well as replicate, emulate, distribute or forward communication data to a remote server using a network, such as the internet. In step 302 a call may be made to a primary communication device from any outside device. In step 304, the incoming call may be recognized and intercepted by the application installed on the primary communication device. In step 306 the intercepted call can be routed over a communication network, such as the internet or in a peer-to-peer fashion, to a remote server or over the network directly to a secondary device. The remote server can then route the call to one or more designated secondary communication devices where, at step 308, it may be received. Then, in step 310, a user can choose to answer the call as desired. Additionally, if the call is answered in step 310 at one of the secondary devices, the secondary devices where the call is not received may no longer indicate that there is an incoming call. Further, as described above, any of a variety of voicemail systems, either at the primary communication device, at a secondary communication device or through the remote calling system application may be utilized.

Referring now to exemplary FIG. 4, a flowchart showing a process for forwarding, replicating or distributing data, such as a text message, may be shown. In step 400, an application for a remote communication system may be installed or, if it is already installed, activated on a primary communication device. As above, this can include software that is capable of communicating with a remote server to share data on the primary communication device as well as forward, replicate or distribute, as desired, communication data to a remote server using a network, such as the internet (or communicated from a primary device to a secondary device in a peer to peer fashion). In step 402 a message may be sent to a primary communication device from any outside device. In step 404, the incoming message may be recognized and intercepted by the application installed on the primary communication device. In step 406 the intercepted message can be routed over a communication network, such as the internet, to a remote server. The remote server can then route the message, or the message may be routed in a peer-to-peer manner, as desired, to one or more designated secondary communication devices where, at step 408, it may be received. As messages are typically read and, in many situations, appear automatically on a screen of a communication device upon receipt, there may be no need to take any further action with respect to the message. Thus, in some examples, the message may be displayed and stored on any of a variety of secondary communication devices. Similarly, the message can still be displayed and stored on the primary communication device. Likewise, if a message is sent from a secondary device, the sent message may be copied and saved by both the application and the primary communication device, as well as any secondary communication device or interface through which the message was sent. Further, in some examples, when a message is read on one device, it may be indicated or marked as “read” on any device that receives or displays the message, including the primary communication device. Further, if it is desired to delete, move or otherwise manipulate a message or other data, an interface on any of a primary device, secondary devices or a central server may be used and may allow for the deletion, moving or manipulation of a message or data on all devices and the server, one device or any combination of devices and the server, as desired.

The foregoing description and accompanying figures illustrate the principles, preferred embodiments and modes of operation of the invention. However, the invention should not be construed as being limited to the particular embodiments discussed above. Additional variations of the embodiments discussed above will be appreciated by those skilled in the art.

Therefore, the above-described embodiments should be regarded as illustrative rather than restrictive. Accordingly, it should be appreciated that variations to those embodiments can be made by those skilled in the art without departing from the scope of the invention as defined by the following claims.

1. A communication system, comprising:
a primary communication device;
a software application installed on the primary communication device;
a network;
a server on the network that houses data associated with the primary communication device; and
at least one secondary communication device receiving at least one of replicated, emulated or cloned data associated with the primary communication device,
wherein the software application detects incoming data transmissions to the primary communication device and routes the data over the network to the at least one secondary communication device, wherein the data housed on the server is accessible and modifiable by the at least one secondary communication device.

2-3. (canceled)

4. The communication system of claim 1, further comprising a server located remotely from the primary communication device and the at least one secondary communication device.

5. The communication system of claim 1, wherein the incoming data transmissions to the primary communication device are at least one of phone calls, text messages and MMS messages.

6. The communication system of claim 1, wherein the software application converts the incoming data transmissions to voice over internet protocol.

7. The communication system of claim 1, wherein the software application allows access of the features of the primary communication device by the at least one secondary communication device.

8. The communication system of claim 7, wherein access of the features of the primary communication device by the at least one secondary communication device includes emulating at least one calls and data messages from the primary communication device by the secondary communication device.

9. The communication system of claim 1, further comprising storage of the incoming data by the first communication device and a server.

10. The communication system of claim 1, wherein the incoming data transmissions are at least one of telephone call data, SMS data and MMS data.

11. The communication system of claim 1, wherein data received at the at least one secondary communication device is stored on at least one of the primary communication device, a server and the at least one secondary communication device.

12. A method of remote communication, comprising:
activating an application on a first communication device;
configuring the application on the first communication device;
detecting incoming data at the first communication device;
intercepting the incoming data at the first communication device;
replicating the incoming data at the first communication device;
routing the incoming data to at least one secondary communication device;
accessing the incoming data at the at least one secondary communication device; and
selectively modifying the incoming data at the at least one secondary communication device.

13. The method of claim 12, further comprising converting the incoming data at the first communication device to voice over internet protocol.

14. The method of claim 12, further comprising distributing the incoming data to the at least one secondary communication device through a server.

15. The method of claim 12, wherein the incoming data is at least one of telephone call data, SMS data and MMS data.

16. The method of claim 12, wherein the first communication device is a smart phone.

17. The method of claim 12, wherein the at least one secondary communication device is at least one of a telephone, a mobile phone, and a computer.
